(19) United States
(12) Patent Application Publication
(10) Pub. No.: US 2026/0094530 A1
(43) Pub. Date: Apr. 2, 2026

(54) IMPROVED DIGITAL CLASSROOM BASED ON STUDENT INTERACTION WITH CLASS CHATBOT

(71) Applicant: Lenovo (United States) Inc., Morrisville, NC (US)

(72) Inventors: Joshua Smith, Morrisville, NC (US); Inna Zolin, Morrisville, NC (US); Tyler Nicholls, Morrisville, NC (US); Sathish Kumar Ganesan, Morrisville, NC (US); Justin Miller, Morrisville, NC (US)

(21) Appl. No.: 18/903,941

(22) Filed: Oct. 1, 2024

(51) Int. Cl. G09B 5/08; G06F 40/40

(52) U.S. Cl. CPC G09B 5/08; G06F 40/40

(57) ABSTRACT

In a digital classroom setting, student inputs to a class chatbot are monitored through various technological processes. Common topics related to the student inputs are identified and surfaced to the class instructor for the instructor to subsequently revisit the common topics in a subsequent class session for greater student understanding.

### FIELD

The disclosure below relates to technically inventive, non-routine solutions that are necessarily rooted in computer technology and that produce concrete technical improvements. In particular, the disclosure below relates to techniques for an improved digital classroom based on student interaction with a class chatbot.

### BACKGROUND

As recognized herein, many computer-centric remote learning environments are emerging in today's technology marketplace. However, these computer-centric learning environments present a new set of challenges that are not necessarily present with in-person learning. As further recognized herein, one such challenge is in determining when students need further aid to understand a particular aspect of the class, since the students and instructor are typically remote from each other. There are currently no adequate solutions to the foregoing computer-related, technological problem.

### SUMMARY

Therefore, the disclosure below presents improvements to computer technology to enable greater student understanding in remote learning environments, informing the instructor of certain topics and class information that should be addressed when students are identified as not understanding something related to the class topic itself.

Accordingly, in one aspect an apparatus includes a processor system and storage accessible to the processor system. The storage includes instructions executable by the processor system to monitor plural student inputs to a class chatbot. Based on the plural student inputs, the instructions are executable to present an output at an instructor client device. The output indicates a common aspect amongst the plural student inputs and recommends a course of action for future class instruction.

In some non-limiting examples, the instructions may be executable to correlate the plural student inputs to a particular class topic that is indicated in a class transcript from a past class session. Based on the correlation, the instructions may then be executable to configure the output to indicate the plural student inputs to the chatbot related to the particular topic. So, for example, the instructions may be executable to determine that the class transcript did not address student queries to the chatbot related to the particular class topic, and then to configure the output to indicate the plural student inputs to the chatbot related to the particular topic responsive to determination. Additionally or alternatively, the instructions may be executable to, based on the correlation, configure the output to recommend that the particular topic be reviewed in a subsequent class session. Also as an example implementation, the instructions may be executable to, responsive to the plural student inputs related to the particular class topic exceeding a threshold number of inputs related to a given class topic, configure the output and present the output at the instructor client device. What's more, in various non-limiting embodiments the instructions may be executable to correlate the plural student inputs to the particular class topic using a classification model, natural language processing, and/or a large language model (LLM).

In various example implementations, the apparatus may include the instructor client device, respective student client devices at which respective inputs of the plural student inputs are received, and/or a server that communicates with the instructor client device to present the output at the instructor client device.

In another aspect, a method includes analyzing plural student inputs to a class chatbot. Based on the analysis of the plural student inputs, the method then includes presenting an output at an instructor client device, with the output indicating a common topic related to the plural student inputs.

In various examples, the output may also recommend a course of action for future class instruction.

Also in various examples, the method may include correlating the plural student inputs to the common topic as indicated in a class transcript from a past class session, and then configuring the output to indicate that the common topic should be addressed in a next class session based on the correlation.

Still further, if desired the method may include determining that the class transcript did not answer student queries to the chatbot related to the common topic. Here, responsive to determination, the method may then include configuring the output to indicate the plural student inputs to the chatbot related to the common topic.

As another example implementation, the method may include, responsive to the plural student inputs related to the common topic exceeding a threshold number of inputs related to a particular class topic, configuring the output and presenting the output at the instructor client device.

In still another aspect, at least one computer readable storage medium (CRSM) that is not a transitory signal includes instructions. The instructions are executable by a processor system to analyze plural student inputs to a class chatbot and, based on the analysis of the plural student inputs, present an output at an instructor client device. The output indicates a common topic related to the plural student inputs.

In one example embodiment, the output may also recommend a course of action for future class instruction.

Also in one example embodiment, the instructions may be executable to correlate the plural student inputs to the common topic as indicated in a class transcript from a past class session and to, based on the correlation, configure the output to indicate that the common topic should be addressed in a next class session.

Still further, if desired the instructions may be executable to analyze the plural student inputs using a classification model, a large language model (LLM), and/or natural language processing.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 shows an example graphical user interface (GUI) that may be presented at a student client device for a student to interact with a digital chatbot consistent with present principles;

FIG. 4 shows an example GUI that may be presented at an instructor client device to present one or more outputs related to student interactions with the digital chatbot consistent with present principles;

FIG. 5 illustrates example logic in example flow chart format that may be executed by a device consistent with present principles;

FIG. 6 illustrates example software architecture that may be implemented consistent with present principles; and

FIG. 7 shows an example GUI that may be presented to configure one or more settings of a device, app, and/or platform to operate consistent with present principles.

### DETAILED DESCRIPTION

Among other things, the detailed description below discusses devices and methods for improving remote classroom instruction based on the students'interactions with a digital chatbot and a teaching transcript. The disclosure below therefore provides improved computer technology that allows teachers and other instructors to make sure that students understand what is being taught throughout online class and to help teachers focus their time on the content their students need to hear the most. Present principles may therefore make use of real-time transcript production via digital assistants to take transcriptions of class sessions and then allow students access to a chatbot that pulls from the transcript data. What's more, the disclosure below also discusses providing teachers with important feedback from the student/chatbot exchange and student interaction with the prior class session(s) transcripts that could help the teacher teach better over time and to focus on topics that are most needed for their students.

So, for example, frequently asked student questions to the chatbot may be surfaced to the teacher, as may summaries of class understanding and a record of student questions to give the teacher even more visibility into the needs of their classroom.

Thus, it is to be understood that a device operating consistent with present principles may capture questions asked by students in K-12 classrooms, for example, and provide real-time intelligent recommendations on what to do with those questions. Recommendations may include when certain topics should be covered, reinforcement schedules for certain ideas (e.g., “reinforce the topic once a week for three weeks to ensure it sticks with students”), and what types of class activities would lend themselves most to the learning of the class's core concepts. The app/platform that is used for search purposes may therefore be customized to the education realm and provide teachers with the information they need to make every moment in the classroom as powerful as possible for their students through the technological advances disclosed herein for remote online learning.

As one specific non-limiting example, in one instance the device may look at all the queries that students made against the classroom transcripts and focus on queries that did not lead to students finding the information they were looking for. The device may then classify and group the failed queries based on the information that was lacking in the class transcript itself. If the number of queries for a specific group exceeds a defined threshold, then the platform may notify the teacher that the topic should be covered again with a focus on the information that was queried.

What's more, if desired the device may feed information back to the chatbot about students asking for a reduced lexicon, asking for chatbot examples to be phrased differently, and/or otherwise requesting a chatbot respond in a different format. For example, if the chatbot's initial response to a student query uses overly-complex verbiage or is too wordy, the student could click the buttons “Simplify” or “Reword” to command the system to regenerate the answer in a way that is easier for the student to understand. A device operating consistent with present principles may therefore incorporate those user inputs into the suggestions for the teacher; for example, “When asking questions about this topic, 60% of the students requested to regenerate chatbot's response to simplify the answer.” Since the chatbot responses are based on the transcripts in non-limiting implementations, 60% of the students requesting regeneration of the chatbot's response would be inferred to mean that the material taught by the teacher or the terminology used by the teacher (as reflected in the transcript) might be too complex and difficult for students to understand, implying to the teacher that there might be a need to simplify the way the lecture is delivered and to reenforce certain topics already covered in past lectures.

As one particular example, suppose a teacher is instructing a class on the American Revolution. Also suppose the teacher has had students ask the following questions to the online chatbot for the online component of the course: “Who was the first president?” “Who led the colonies troops?” “Name some of the heroes of the revolution.” An online teaching platform operating consistent with present principles may, in response, recommend that the teacher spend some time talking about George Washington and some of the other Founding Fathers in a next class session, addressing the past student queries to the chatbot in the process.

On a technical level, a device operating consistent with present principles may use various artificial intelligence (AI) algorithms to effect the improvements to computer technology disclosed herein. Therefore, AI in the form of natural language processing, large language models, and classification models may be used, among others.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used, as may a Chrome or Android or Windows or macOS or iOS operating system. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single-or multi-chip processor that can execute logic by means of various lines such as address lines, data lines, and control lines and registers and shift registers. Moreover, any logical blocks, modules, and circuits described herein can be implemented or performed with a system processor such as a central processing unit (CPU), a graphics processing unit (GPU), a neural processing unit (NPU), a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in the art. Where employed, the software instructions may also be embodied in a non-transitory device that is being vended and/or provided, and that is not a transitory, propagating signal and/or a signal per se. For instance, the non-transitory device may be or include a hard disk drive, solid state drive, or CD ROM. Flash drives may also be used for storing the instructions. Additionally, the software code instructions may also be downloaded over the Internet (e.g., as part of an application (“app”) or software file). Accordingly, it is to be understood that although a software application for undertaking present principles may be vended with a device such as the system 100 described below, such an application may also be downloaded from a server to a device over a network such as the Internet. An application can also run on a server and associated presentations may be displayed through a browser (and/or through a dedicated companion app) on a client device in communication with the server.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library. Also, the user interfaces (UI)/graphical UIs described herein may be consolidated and/or expanded, and UI elements may be mixed and matched between UIs. Logic when implemented in software, can be written in an appropriate language such as but not limited to hypertext markup language (HTML)-5, Java®/JavaScript, C# or C++, and can be stored on or transmitted from a computer-readable storage medium such as a hard disk drive (HDD) or solid state drive (SSD), a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

The term “a” or “an” in reference to an entity refers to one or more of that entity. As such, the terms “a” or “an”, “one or more”, and “at least one” can be used interchangeably herein.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. The term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

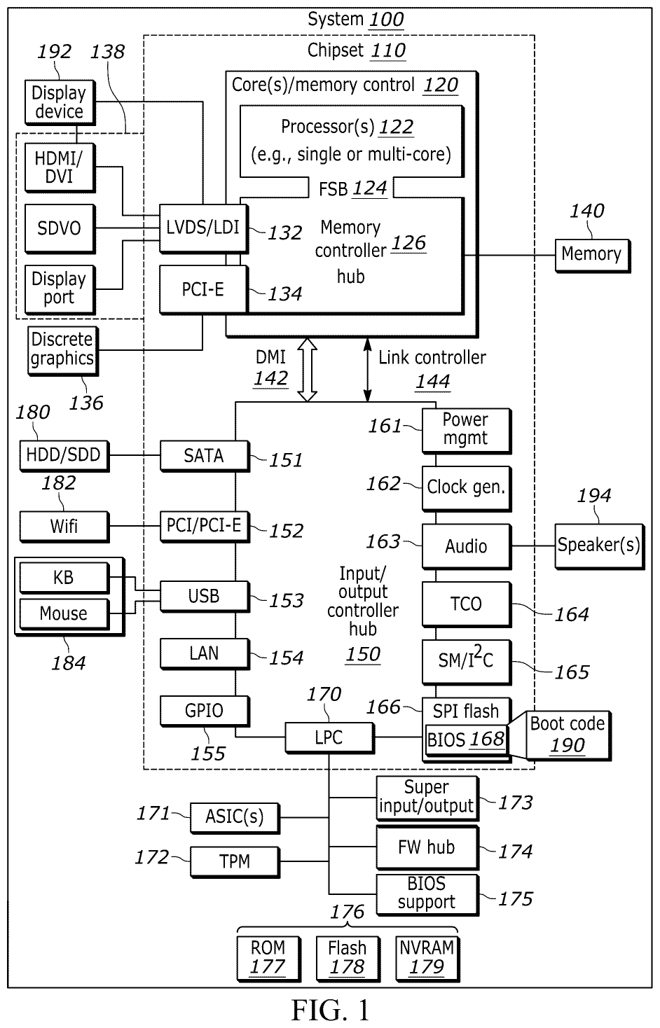

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre®, or notebook computer system, such as ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 includes a processor system 122 (e.g., one or more single core or multi-core processors, etc.) and a memory controller hub 126 that exchange information via a front side bus (FSB) 124. A processor system such as the system 122 may therefore include one or more processors acting independently or in concert with each other to execute an algorithm, whether those processors are in one device or more than one device. Additionally, as described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. For example, the memory controller hub 126 may include a 16-lane (x16) PCI-E port for an external PCI-E-based graphics card (including, e.g., one or more GPUs). An example system may thus include PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface. Example network connections include Wi-Fi as well as wide-area networks (WANs) such as 4G and 5G cellular networks.

The interfaces of the I/O hub controller 150 may provide for communication with various devices, networks, etc. For example, where used, the SATA interface 151 and/or PCI-E interface 152 provide for reading, writing or reading and writing information on one or more drives 180 such as HDDs, SSDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for simplicity, in some embodiments the system 100 may include a gyroscope that senses and/or measures the orientation of the system 100 and provides related input to the processor system 122, an accelerometer that senses acceleration and/or movement of the system 100 and provides related input to the processor system 122, and/or a magnetometer that senses and/or measures directional movement of the system 100 and provides related input to the processor system 122.

Still further, the system 100 may include an audio receiver/microphone that provides input from the microphone to the processor system 122 based on audio that is detected, such as via a user providing audible input to the microphone. The system 100 may also include a camera that gathers one or more images and provides the images and related input (e.g., metadata like an image timestamp) to the processor system 122. The camera may be a thermal imaging camera, an infrared (IR) camera, a digital camera such as a webcam, a three-dimensional (3D) camera, and/or a camera otherwise integrated into the system 100 and controllable by the processor system 122 to gather still images and/or video.

Also, the system 100 may include a global positioning system (GPS) transceiver that is configured to communicate with satellites to receive/identify geographic position information and provide the geographic position information to the processor system 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network trained through machine learning may thus include an input layer, an output layer, and multiple hidden layers in between that are configured and weighted to make inferences about an appropriate output.

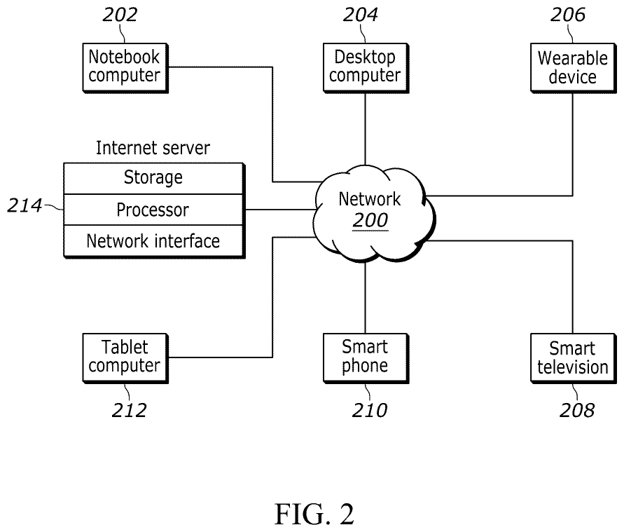

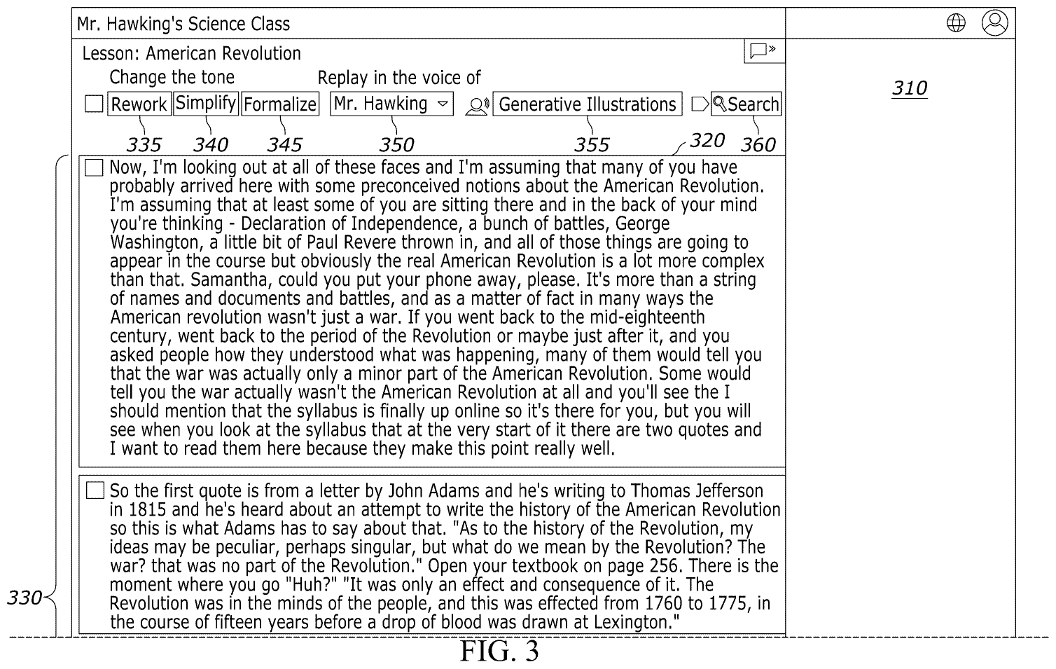

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 may be configured to communicate with each other over the network 200 to undertake present principles.

Thus, in one example, smartphones 210 may establish respective client devices used by an instructor and two students within an online class setting, while the server 214 may communicate with those client devices to present an output at the instructor client device to clarify any misconceptions of the students about a class topic as evidenced by the students' interactions with a class chatbot.

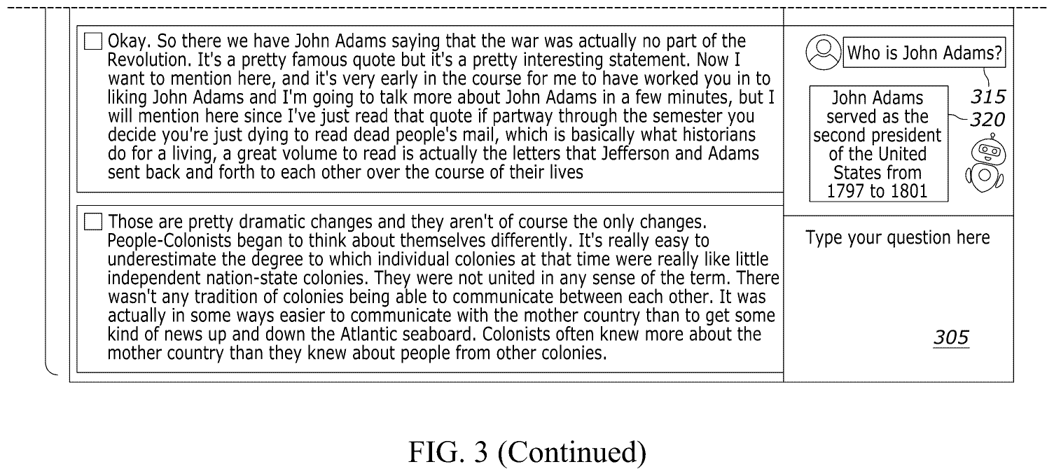

With the foregoing in mind, reference is now made to FIG. 3. Suppose a student is reviewing material online that is related to a topic recently studied in the student's class, whether that is a K-12 class, an undergraduate-level class, a graduate-level class, a vocational class, etc. In the present example, assume the class is a twelfth grade history class and that the class is currently studying the American Revolution. Also suppose the class itself may be partially or fully virtual and, as such, class materials have been posted online through the online platform being used for the class. In one particular example, the platform may be Lenovo's LanSchool platform, though other platforms may also be used consistent with present principles.

Now suppose the platform hosts a chatbot to which the human users (the students) can submit questions related to the material of the class for the chatbot to provide responses to aid the students'understanding. The chatbot may therefore be an autonomous, conversational digital assistant that is configured to respond to user queries. In various examples, the chatbot may be established by a digital assistant akin to Amazon's Alexa, Google's Assistant, Apple's Siri, etc. Additionally or alternatively, the chatbot may be established by a large language model (LLM) or other software capable of receiving and responding to user queries and, as such, may be established by an LLM such as Claude, Gemini, ChatGPT, etc.

FIG. 3 thus shows a graphical user interface (GUI) 300 through which each student can interact, through the platform, with the chatbot. As such, the GUI 300 may include an input box 305 into which the student may type a query or other user input using a hard or soft keyboard. Once input has been provided to the box 305 and the user submits the query (e.g., by selecting “enter” on the keyboard), the input as provided by the user may be populated into a conversation string 310 as a first input 315. The chatbot may then process the student's input and provide a response that is also included in the conversation string 310 as a first output 320.

In the present example, the student's query 315 to the chatbot is, “Who is John Adams?” The chatbot's response 320 is, “John Adams served as the second president of the United States from 1797 to 1801.” Note here that the response 320 may not be a predetermined response, but may instead be a generative response provided by an LLM or other generative model based on one or more transcripts of a prior class session of the student's class. The transcript itself may indicate audible words spoken by the class's teacher or other instructor, and in some examples might also indicate audible words spoken by other people as well, where the words are sensed by one or more live microphones and then converted into text using speech-to-text software to generate the transcript itself. Thus, the LLM may parse the transcript according to this example and then reformulate facts and ideas noted in the transcript into a new string of words that responds to the chatbot query (but is not repeated verbatim in the transcript itself).

In addition to or in lieu of providing the generative response 320, the platform may also present one or more excerpts from transcript(s) of one or more prior class sessions that have already transpired, where those excerpts were determined by the chatbot as providing information that responds to the user's query (in this case, information on John Adams to help answer the student's query). As such, a listing 325 of the respective excerpts 330 is shown. Each excerpt may be selectable to present the full transcript from the respective class session, or at least to present other portions of the same transcript before and after the selected excerpt, for the student to gain additional context about the content of the excerpt itself. For example, the immediately before/after transcript portions may be additional portions that have been identified as being directed to the same topic (John Adams) as the excerpt itself, with other portions of the relevant transcript that are directed to different topics being omitted. Additionally or alternatively, each except may be selectable to initiate audio playback of the audio recording of the class session itself (at least a portion of the recording during which the words of the excerpt were spoken).

FIG. 3 also shows that the GUI 300 may include one or more controls, including tone controls to change the tone of the chatbot's prior response by rewording the prior response (selector 335), simplifying the prior response (selector 340), or formalizing the prior response (selector 345). Note that inputs to select the selectors 335-345 may also be used by the platform to infer that the material taught by the teacher or the terminology used in doing so might be too complex and difficult for the students to understand. This in turn may be used by the platform to recommend to the teacher that there might be a need to simplify the way the lecture is delivered, such as by indicating the following to the instructor in an instructor suggestion/output: “When asking questions about this topic, 60% of the students requested to regenerate chatbot's response to simplify the answer.”

Another control in the form of a drop-down menu 350 may also be presented on the GUI 300, where different options on the drop-down menu 350 allow the student to select different voices in which the platform is to read aloud a selected excerpt 330 responsive to selection of the excerpt itself. Additionally or alternatively, the selected voice may be used to audibly present the generative chatbot responses (including the response 320) responsive to selection of the response from the string 310. The voices themselves may be computer-generated voices, including fictional voices and/or the voices of real people whose voices have been modeled by a deepfake voice generator model. In the present example, the student has selected the voice of the class's teaching assistant, Mr. Hawking. As such, the deepfake voice generator model as trained on audio samples of Mr. Hawking's voice may be used audibly read aloud one or more selected excerpts 330 over the student's local speakers, and/or to read aloud the chatbot response 320 over the student's local speakers.

In some examples, the GUI 300 may also include a selector 355 that may be selectable to command the platform to generate one or more generative illustrations/images from the excerpts 330 and/or response 320 to further aid the student's understanding based on the query submitted by the student themselves. Therefore, note here that a large multimodal model (LMM) may also be used, where the LMM may take the transcripts and/or a class audio recording as input and generate an image in response that captures the content of the transcripts and/or class audio. The image might include a portrait of the relevant person (John Adams), a diagram of the relationship of the topic in question to other related topics discussed in class, etc.

What's more, if desired the GUI 300 may include a search bar 360 into which a user may enter one or more keywords to directly search the transcript(s) and/or excerpts 330 themselves for the corresponding keywords. A list of conforming texts may therefore be presented based on the keywords entered into the bar 360.

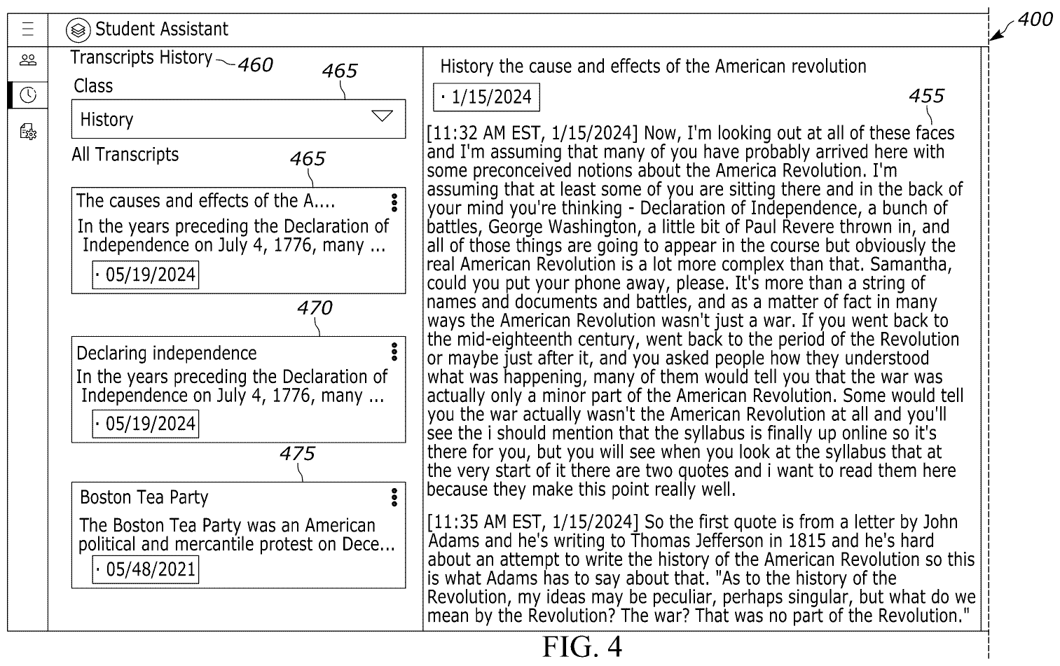

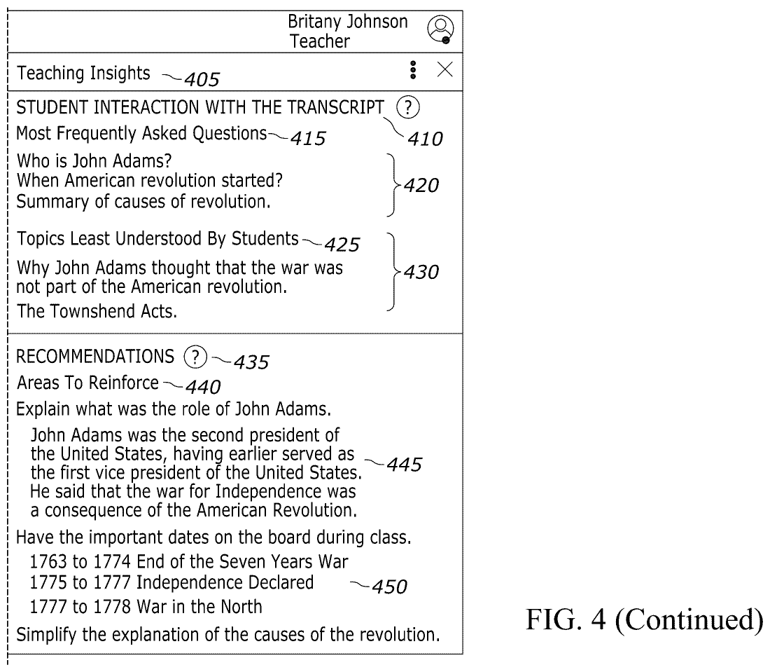

Turning to FIG. 4, also suppose that as each student interacts with the chatbot, the platform monitors the student inputs as well as chatbot responses. Further assume that the platform has determined based on the monitoring that the chatbot fails to provide answers to a particular topic indicated in plural student queries and/or that more than a threshold number of student queries to the chatbot have been received in relation to the particular topic. Since this may indicate an overall lack of understanding about a topic amongst the class at large, the class's instructor may be notified by the platform via the GUI 400 of FIG. 4, with the GUI 400 being accessible through the instructor's own account on the same online classroom platform.

As such, the GUI 400 may include a teaching insights area 405. The teaching insights area may include one or more different types of outputs, including a first output type 410 indicating student interaction with the prior class transcript(s). A first sub-type 415 of the type 410 may be frequently asked questions (FAQs) as identified by the platform based on student queries received in relation to the relevant topic itself and/or the prior class session transcript. Therefore, as shown, the GUI 400 may include a listing 420 of FAQs submitted by the students to the chatbot.

The area 405 may also indicate a second sub-type 425 of the type 410, which in the present example may be topics least understood by the students as indicated in their chatbot queries. As shown in FIG. 4, the topics may be presented as a list 430.

Note here that the FAQs and topics as presented in the listings 420, 430 may be verbatim inputs from the students themselves to the chatbot. Additionally or alternatively, the FAQs and topics presented in the listings 420, 430 may be generative outputs distilled and/or synthesized by the platform/LLM based on the actual student queries to the chatbot, where the queries might vary to a certain degree but may still be classified as relating to a particular FAQ or topic by the platform using techniques set forth below (e.g., natural language processing).

As also shown in FIG. 4, the area 405 may include recommendations 435 of courses of action for the instructor to take for future class instruction. According to this example, the recommendations 435 may include a section 440 of areas (topics) of the class to reinforce to the students during a subsequent live session, through email, and/or through other online communication methods. In the present example, the section 440 lists example areas as “Explain what was the role of John Adams”, “Have the important dates on the board during class”, and “Simplify the explanation of the causes of the Revolution”. Thus, note that the section 440 may indicate not just topic areas to reinforce, but specific teaching methods for during so (explaining/simplifying certain information and putting dates on the virtual whiteboard in this example).

Further note that, for each area presented in the section 440, additional auto-generated information 445, 450 about the respective area may be presented to provide further aid to the teacher in terms of specific content to bring up to the students. The auto-generated information 445, 450 may be sourced from the transcript of a prior class (e.g., verbatim or as synthesized by the platform's LLM), and/or may be sourced from other sources such as reputable Internet websites, online teaching materials and teaching aids, etc.

As also shown in FIG. 4, the GUI 400 may include a timestamped transcript(s) 455 of part of a prior class session(s) that the platform has determined is relevant to the teaching insights area 405. For example, the parts of the transcript 445 presented on the GUI 400 may be portions during which class content answering the FAQs 415 were discussed, class content in which the topics least understood 425 were discussed, and/or class content including detailed information on the areas to reinforce 440.

If desired, in some examples the GUI 400 may include an area 460 with additional technical features that the teacher may find useful. For example, the area 460 may include a drop-down menu 465 for the teacher to toggle between different classes the teacher is currently teaching via the platform. As also shown in FIG. 4, the area 460 may include respective selectors 465-475 that are each selectable to present a different associated transcript from a different (previous) class session(s).

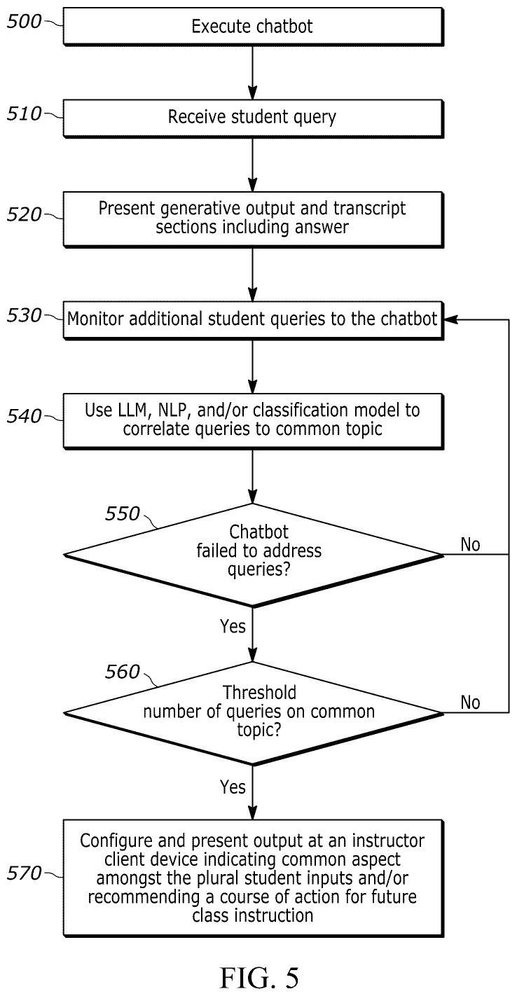

Referring now to FIG. 5, it shows example logic that may be executed by a device such as the system 100 and/or a coordinating server alone or in any appropriate combination consistent with present principles. Thus, in some examples the logic may be executed by a client device alone. In other examples, the logic may be executed by the remotely-located server alone. In still other examples, the logic may be executed by a client device and remotely-located server, where the client device performs some steps while the server performs other steps, and/or where the client device and server work together to perform a given step. Note that while the logic of FIG. 5 is shown in flow chart format, other suitable logic may also be used (e.g., state machine).

Beginning at block 500, the device may execute a chatbot. Then at block 510 the device may receive a student query to the chatbot consistent with the disclosure above. From block 510 the logic may then proceed to block 520 where the device may present a generative output and transcript sections indicating an answer to the student's query, as also set forth above. For example, at block 520 the logic may present one or more of the outputs of FIG. 3, such as the generative output 320 and transcript excerpts 330.

From block 520 the logic may then proceed to block 530. At block 530 the device may monitor plural student inputs to a class chatbot, including the input received at block 510 as well as any additional student inputs from the same student and/or different students from the same class. Accordingly, as part of the monitoring, at block 540 the device may use an LLM, natural language processing (NLP) software, and/or a classification model to analyze and correlate queries and other input from the students (still to the chatbot) to a common, particular class topic. Again note that the particular class topic might be indicated in one or more class transcripts from one or more past class sessions.

So, for example, the LLM may process the student inputs to identify a common theme or topic being asked through the student inputs. It may do so based on the vectorization of the inputs themselves, with the LLM linking the inputs in vector space to determine their common topic.

As another example, NLP algorithms such as topic segmentation and topic understanding algorithms may be executed. Another NLP algorithm that may be executed may be a natural language understanding algorithm. Topics common amongst one or more student inputs may therefore be inferred using those algorithms.

As yet another example in addition to or in lieu of the foregoing, a classification model may be executed to identify one or more topics that were shared amongst the one or more student inputs to the chatbot. The classification model may be embodied as, but is not limited to, a convolutional neural network.

From block 540, the logic of FIG. 5 may proceed directly to block 570 as will be described in a moment. However, in other examples, the logic of FIG. 5 may proceed from block 540 to either or both of decision diamonds 550 and 560 before reaching block 570.

At diamond 550 the device may determine whether the chatbot failed to address one or more student queries. For example, at diamond 550 the device may determine whether the prior class transcript(s) failed to address student queries related to the particular class topic (and therefore that the chatbot itself failed to provide responses to the queries using the transcript(s) as ground truth information for output to the students). Or as another example, chatbot processing may have timed out based on the student queries being overly-complicated or confusing, which might have rendered the queries indecipherable to the chatbot and the chatbot therefore being unable to provide an answer (hence being indicative of student confusion on the determined topic).

A negative determination at diamond 550 may cause the logic to revert back to block 530 to proceed again therefrom. However, an affirmative determination at diamond 550 may cause the logic to either proceed directly to block 570 or to move to diamond 560 beforehand.

At diamond 560 the device may determine whether the plural student inputs related to the particular class topic exceed a threshold number of inputs related to a given class topic. The threshold may therefore be one related to a threshold number of inputs to the chatbot as received in relation to any one topic. A negative determination at diamond 560 may cause the logic to revert back to block 530. However, responsive to the plural student inputs related to the common topic exceeding the threshold number of inputs related to the particular class topic, the logic may instead proceed to the aforementioned block 570.

At block 570 the device may configure and present one or more outputs to the class's teacher/instructor at the instructor's client device. The outputs may therefore be configured to indicate the plural student inputs to the chatbot that are related to the particular topic (and/or other common aspects amongst the plural student inputs). The outputs may also recommend a course of action for future class instruction and indicate other items mentioned above with respect to FIG. 4. For example, in certain particular instances, an output may recommend that the particular topic be reviewed and addressed in a subsequent class session to occur in the future, or otherwise recommend a course of action for future class instruction.

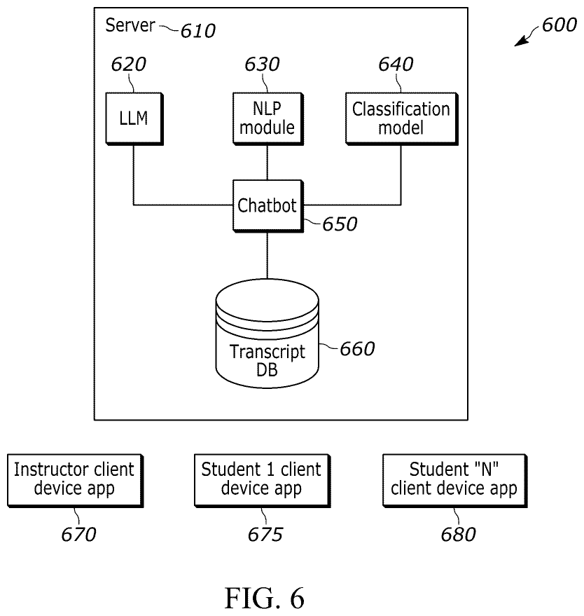

Now in reference to FIG. 6, example software architecture 600 is shown that may be implemented consistent with present principles. However, present principles are not limited to the architecture 600 of FIG. 6 as other configurations are also encompassed by present principles.

In any case, as shown in FIG. 6, a server 610 may have one or more software components residing on it, including an LLM 620, an NLP module 630, and a classification model 640. Those three software components may be in communication with a chatbot 650, with the chatbot 650 having access to a transcript database 660. The database 660 may store transcripts of past class sessions for use consistent with present principles. Also note that the database 660 may be directly accessible to not just the chatbot 650 but also the components 620-640.

FIG. 6 also shows that one or more client-side applications (“apps”) for the same platform that manages the server 610 may be executed at respective client devices 670-680, with the devices 670-680 being in communication with the server 610 over the Internet or another network to undertake present principles. Thus, an instance of the app unique to class instructors may be executed at the instructor client device 670 to present the GUI 400 of FIG. 4. Two other end-user instances of the app for the class's students may be executed at the student client devices 675, 680 to present the GUI 300 of FIG. 3.

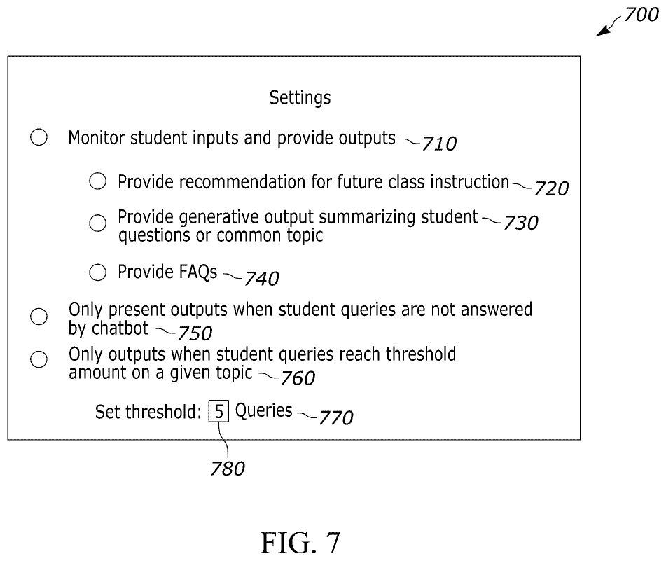

Continuing the detailed description in reference to FIG. 7, it shows an example GUI 700 that may be presented on a display for an end-user to configure one or more settings of an apparatus, software application (“app”), and/or class platform to operate consistent with present principles. Each option discussed below may be selected by selecting the respective radio button shown adjacent to that option, whether through cursor input, touch input, or another type of input.

As shown in FIG. 7, the GUI 700 may include an option 710 that is selectable to set or configure the app to undertake present principles. Therefore, in one example selection of the option 710 a single time may configure the device to, for multiple future instances, execute the functions described above in reference to FIGS. 3-6. The option 710 may be accompanied by one or more sub-options 720-740. Each sub-option may configure the app to present a different type of output.

For example, the sub-option 720 may be selected to set or configure the device to provide outputs in the form of recommendations for future class instruction on a given topic with which the students are struggling, as evidenced by their interactions with the class chatbot. Sub-option 730 may be selected to set or configure the device to provide generative outputs summarizing student questions on the common topic with which the students are struggling. Sub-option 740 may be selected to set or configure the device to list frequently asked questions identified from the student interactions with the chatbot. Any of the other example outputs described herein may be listed as a respective sub-option as well, with only three being shown as an example.

As also shown in FIG. 7, the GUI 700 may include an option 750 that is selectable to set or configure the app to only present instructor outputs when student queries are not answered by the chatbot itself. Thus, selection of the option 750 may set the app to execute the determination of diamond 550 or, if not selected, set the app to present instructor outputs regardless of whether the chatbot provided answers directly back to the student(s).

The GUI 700 may further include an option 760 that is selectable to set or configure the app to only present instructor outputs responsive to student queries on a given topic reaching a threshold amount. Thus, selection of the option 760 may set the app to execute the determination of diamond 560 or, if not selected, set the app to present instructor outputs regardless of whether the threshold number has been reached. Further note that the threshold number itself may be established by the end-user by entering a number into the number entry box 780.

It may now be appreciated that present principles provide for an improved computer-based user interface that increases the functionality and ease of use of the devices disclosed herein. The disclosed concepts are rooted in computer technology for computers to carry out their functions.

Components included in one embodiment can be used in other embodiments in any appropriate combination. For example, any of the various components described herein and/or depicted in the Figures may be combined, interchanged or excluded from other embodiments.

It is to be understood that whilst present principals have been described with reference to some example embodiments, these are not intended to be limiting, and that various alternative arrangements may be used to implement the subject matter claimed herein. Accordingly, while particular techniques and devices are herein shown and described in detail, it is to be understood that the subject matter which is encompassed by the present application is limited only by the claims.

What is claimed is:

1. An apparatus, comprising:
a processor system; and
storage accessible to the processor system and comprising instructions executable by the processor system to:
monitor plural student inputs to a class chatbot; and
based on the plural student inputs, present an output at an instructor client device, the output indicating a common aspect amongst the plural student inputs, the output recommending a course of action for future class instruction.

2. The apparatus of claim 1, wherein the instructions are executable to:
correlate the plural student inputs to a particular class topic that is indicated in a class transcript from a past class session; and
based on the correlation, configure the output to indicate the plural student inputs to the chatbot related to the particular topic.

3. The apparatus of claim 2, wherein the instructions are executable to:
determine that the class transcript did not address student queries, to the chatbot, related to the particular class topic; and
responsive to determination, configure the output to indicate the plural student inputs to the chatbot related to the particular topic.

4. The apparatus of claim 2, wherein the instructions are executable to:
based on the correlation, configure the output to recommend that the particular topic be reviewed in a subsequent class session.

5. The apparatus of claim 2, wherein the instructions are executable to:
responsive to the plural student inputs related to the particular class topic exceeding a threshold number of inputs related to a given class topic, configure the output and present the output at the instructor client device.

6. The apparatus of claim 2, wherein the instructions are executable to:
correlate the plural student inputs to the particular class topic using a classification model.

7. The apparatus of claim 2, wherein the instructions are executable to:
correlate the plural student inputs to the particular class topic using natural language processing.

8. The apparatus of claim 2, wherein the instructions are executable to:
correlate the plural student inputs to the particular class topic using a large language model (LLM).

9. The apparatus of claim 1, comprising the instructor client device.

10. The apparatus of claim 9, comprising respective student client devices at which respective inputs of the plural student inputs are received.

11. The apparatus of claim 1, comprising a server that communicates with the instructor client device to present the output at the instructor client device.

12. A method, comprising:
analyzing plural student inputs to a class chatbot; and
based on the analysis of the plural student inputs, presenting an output at an instructor client device, the output indicating a common topic related to the plural student inputs.

13. The method of claim 12, wherein the output recommends a course of action for future class instruction.

14. The method of claim 12, comprising:
correlating the plural student inputs to the common topic as indicated in a class transcript from a past class session; and
based on the correlation, configuring the output to indicate that the common topic should be addressed in a next class session.

15. The method of claim 14, comprising:
determining that the class transcript did not answer student queries, to the chatbot, related to the common topic; and
responsive to determination, configuring the output to indicate the plural student inputs to the chatbot related to the common topic.

16. The method of claim 12, comprising:
responsive to the plural student inputs related to the common topic exceeding a threshold number of inputs related to a particular class topic, configuring the output and presenting the output at the instructor client device.

17. At least one computer readable storage medium (CRSM) that is not a transitory signal, the at least one CRSM comprising instructions executable by a processor system to:
analyze plural student inputs to a class chatbot; and
based on the analysis of the plural student inputs, present an output at an instructor client device, the output indicating a common topic related to the plural student inputs.

18. The at least one CRSM of claim 17, wherein the output recommends a course of action for future class instruction.

19. The at least one CRSM of claim 17, wherein the instructions are executable to:
correlate the plural student inputs to the common topic as indicated in a class transcript from a past class session; and
based on the correlation, configure the output to indicate that the common topic should be addressed in a next class session.

20. The at least one CRSM of claim 17, wherein the instructions are executable to:
analyze the plural student inputs using one or more of: a classification model, a large language model (LLM), natural language processing.
